(19) United States
(12) Patent Application Publication
(10) Pub. No.: US 2008/0155053 A1
(43) Pub. Date: Jun. 26, 2008

(54) SYSTEM AND METHOD FOR DISTRIBUTING INDIVIDUATED INFORMATION

(75) Inventors: Wei Shen, Beijing (CN); Ye Liu, Beijing (CN); Hongqiang Zhang, Beijing (CN)

Correspondence Address: AKERMAN SENTERFITT, P.O. BOX 3188, WEST PALM BEACH, FL, 33402-3188, US

(73) Assignee: Gmedia Corporation, Georgetown (KY)

(21) Appl. No.: 11/959,001

(22) Filed: Dec. 18, 2007

(30) Foreign Application Priority Data
Dec. 25, 2006 (CN) 200610168071.8

(51) Int. Cl. G06F 15/16

(52) U.S. Cl. 709/217

(57) ABSTRACT

Methods and systems of distributing individualized information are presented. First a mobile terminal with an identifier is used to read an information carrier to obtain at least one piece of identification-information carried on the information carrier, then it is determined whether the at least one piece of identification-information is matched with at least one of multiple pieces of pre-stored identification-information. If there is a match, at least one piece of distribution information associated with the identifier is determined from a set of distribution information associated with the at least one piece of identification-information according to at least one identifier matching rule matched with the identifier. The individualized methods and systems of the present invention greatly reduce requirements for network resource and computation resource.

### TECHNICAL FIELD

The present invention generally relates to information distributing technology in communication field, and more particularly, to a system and a method for distributing individuated information.

### BACKGROUND

As fast development of mobile communication, mobile terminals such as mobile phone, PDA and the like are widely used. At the same time, the concept of using mobile terminals as information platform emerges, where an information provider may distribute information to users having mobile terminals through mobile communication carriers. This manner has advantages of large information quantity, convenience and fastness.

However, in current information distributing mode, the information providers typically provide same information to all users, and are not capable of differentiating various users, especially in large scale information distribution. As for a user, he generally receives amounts of non-relevant information passively. When the users do not need the information distributed by the information provider, this communication between them is meaningless, and may cause considerable waste of network resource and computation resource. Furthermore, the information provider is not able to provide real-time applications such as stream media, audio and video under this circumstance, because it is not feasible with current network condition to provide these kinds of real-time services to numerous users. Additionally, even though the network condition is improved, reception of information will still be affected if types of hardware or software in users' mobile terminals are not suitable for displaying the distributed information, for example, the displaying screens being too small, or the decoding schemes being not supported.

With requirements for individualized services becoming higher, this problem is even more prominent. People start to consider “content negotiation” of a mobile terminal with a server end, i.e., the server distributing information for individual users in case of specifically knowing the specific condition of the mobile terminals (and their users). For example, corresponding information about service provider may be sent according to demand of a user and the city in which the user is resided, or corresponding audio and video contents may be provided according to the type of the user's mobile equipment.

The present invention is aimed to provide a system and a method of distributing individualized information, which distribute individualized information by reading an information carrier with a mobile terminal to actively require interaction and by determining identifier information of the mobile terminal. Meanwhile, the method and system of the present invention greatly reduce requirements for network resource and computation resource due to extremely high pertinence of the method and system.

### SUMMARY OF THE INVENTION

In accordance with one aspect of the present invention, a method of distributing information is provided, which comprises reading an information carrier using a mobile terminal with an identifier to obtain at least one piece of identification-information on the information carrier; determining whether the at least one piece of identification-information is matched with at least one of multiple pieces of pre-stored identification-information, if matched, determining at least one piece of distribution information associated with the identifier from a set of distribution information associated with the at least one piece of identification-information according to at least one identifier matching rule matched with the identifier. The method of distributing information further comprises determining the at least one identifier matching rule matched with the identifier from a predetermined set of identifier matching rules. The method of distributing information may further comprise if the at least one piece of identification-information is not matched with any one of the multiple pieces of pre-stored identification-information, sending an error message to the mobile terminal. The method of distributing information may further comprise after the operation of ‘determining at least one piece of distribution information associated with the identifier from a set of distribution information associated with the at least one piece of identification-information according to at least one identifier matching rule matched with the identifier’, sending the determined at least one piece of distribution information to the mobile terminal with the identifier.

In accordance with another aspect of the present invention, a system of distributing information is provided, which comprises: a communication network; at least one mobile terminal with an identifier, the mobile terminal is coupled with the communication network and comprising a reading module for reading an information carrier to obtain at least one piece of identification-information on the information carrier and a communication module for sending the at least one piece of identification-information obtained by the reading module via the communication network; and a server coupled to the communication network and communicating with the at least one mobile terminal, the server comprising a memory for storing multiple pieces of pre-stored identification-information, an identification-information matching logic for determining whether the at least one piece of identification-information is matched with at least one of the multiple pieces of pre-stored identification-information, and a distributing logic for determining at least one piece of distribution information associated with the identifier from a set of distribution information associated with the at least one piece of identification-information according to at least one identifier matching rule matched with the identifier. The system of distributing information may further comprises an identifier matching logic for determining the at least one identifier matching rule matched with the identifier from a predetermined set of identifier matching rules. If the at least one piece of identification-information is not matched with any one of the multiple pieces of pre-stored identification-information, the server sends an error message to the mobile terminal. If the identification-information is matched with one of the multiple pieces of pre-stored identification-information, the server sends the at least one piece of distribution information determined by the distributing logic according to the at least one identifier matching rule matched with the identifier to the mobile terminal with the identifier.

In accordance with various aspects of the present invention, the identifier includes at least one of user agent data of the mobile terminal, user number of the mobile terminal, international mobile equipment identity, Mobile Country Code, Mobile Network Code, Location Area Code or a combination thereof, the information carrier includes at least one of barcode, two-dimensional code, RF identity tag, optically-recognizable character or a combination thereof. The information carrier may include a DM code, and the reading module reads the DM code in an optical manner and decodes the DM code to obtain the at least one piece of identification-information. The identifier matching logic may obtain the identifier from a gateway, or may obtain the pre-stored identifier locally. The identifier matching rule may include at least one of number matching, number segment matching, area matching, network-type matching and matching of mobile terminal model, or a combination thereof.

### DESCRIPTION OF THE DRAWINGS

In the following detailed description, reference is made to the accompanying drawings, which show by way of illustration specific embodiments in which the invention may be practiced. However, it is to be understood that other embodiments will become apparent to those of ordinary skill in the art upon reading this disclosure. The following detailed description is, therefore, not to be construed in a limiting sense, as the scope of the present invention is defined by the claims.

FIG. 1 illustrates a block diagram of an information distributing system of the present invention according to one embodiment of the present invention;

FIG. 2 further illustrates operations of a server in the system of the present invention according to another embodiment of the present invention;

FIG. 3 shows exemplary hardware implementation of individual modules in the server of the present invention according to yet another embodiment of the present invention.

FIG. 4 illustrates a flow chart of information distributing process according to an embodiment of the present invention.

### DETAILED DESCRIPTION

In the description below, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Any number of variations of the inventive concept are anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

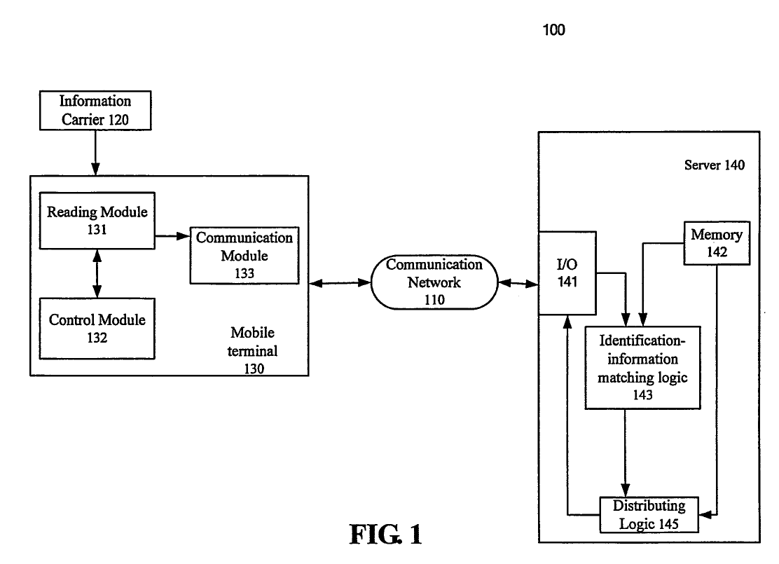

FIG. 1 illustrates a block diagram of an information distributing system 100 of the present invention according to one embodiment of the present invention. The information distributing system 100 includes a communication network 110, as well as at least one mobile terminal 130 and at least one server 140 which communicate with each other via the communication network 110. The mobile terminal 130 may include, but not limited to, mobile phone, Personal Digital Assistant (PDA) and so on, the communication network 110 may be Internet, mobile Internet, Local area network, Wide area network, and the mobile terminal 130 may communicate in wired, wireless, infrared, Blue tooth, radio frequency, WiFi, WiMax and the like manners. As those skilled in the art may understand, the mobile terminal has an identifier which may include at least one of, for example, user agent (UA) data of the mobile terminal, user number of the mobile terminal, international mobile equipment identity, Mobile Country Code (MCC), Mobile Network Code (MNC), Location Area Code (LAC) or a combination thereof.

The mobile terminal 130 may include a reading module 131, a control module 132 and a communication module 133. The mobile terminal 130 reads an information carrier 120 through the reading module 131 to obtain identification-information on the information carrier 120, sends the obtained identification-information via the communication 133 under the control of the control module 132. The information carrier 120 may include at least one of barcode, two-dimensional code, RF identity tag, optically-recognizable character or a combination thereof, but the present invention is not limited in this aspect. For example, the information carrier may be a Data Matrix (DM) code, and the mobile terminal may read the DM code in optic means, and obtain the identification-information encoded into this DM code by decoding the DM code in technologies known in the art or developed in the further.

In Chinese patent application publication CN1632811, a variety of two-dimensional codes are also disclosed, and those skilled in the art may understand that two-dimensional codes of these types may be applicable in the present invention. The decoded two-dimensional code information may be a piece of information comprised of 16 characters. Those skilled in the art should also understand that the decoding schemes associated with the above mentioned kinds of two-dimensional codes may be used to decode the two-dimensional code of the present invention. Furthermore, as described in the application tiled in “System and Method for Collecting and Analyzing a Multi-fields Two-dimensional code”, filed by the applicant of the present application on the same day, the two-dimensional code of the present invention may be a multi-fields two-dimensional code.

The server 140 may include an I/O module 141, a memory 142, an identification-information matching logic 143 and a distributing logic 145. The identification-information matching logic 143 receives the identification-information from the mobile terminal via network through the I/O module 141, and determines whether the received identification-information is matched with one of multiple pieces of identification-information pre-stored in the memory. In response to a matching result sent out by the identification-information matching logic 143, the distributing logic 145 selects at least one piece of distribution information which is determined to be associated with the identifier of the mobile terminal 130 from a set of distribution information associated with the identification-information according to at least one identifier-matching rule which is matched with the identifier, and distributes the selected distribution information to the mobile terminal with this identifier via the communication network 110. The operational mode of the server will be described below in great details referring to one embodiment of the present invention.

The skilled persons in the art should understand that although various separate modules are shown in FIG. 1 for purpose of clarity and convenient for explanation, these modules may also be integrated. In addition, the present system may further include other modules as desired in addition to the shown modules, and the present invention is not limited in this aspect.

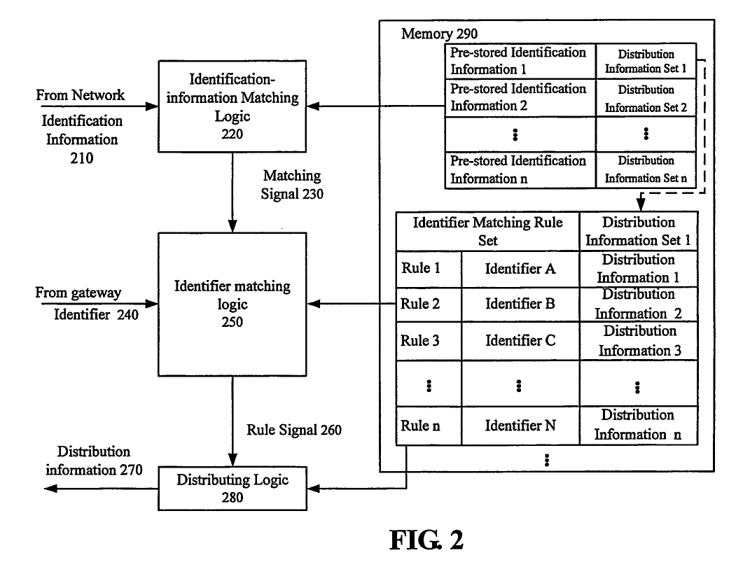

FIG. 2 further illustrates operations of the server in the system of the present invention according to another embodiment of the present invention. As shown in the figure, an identification-information matching logic 220 receives identification-information 210 from a network, determines whether there is one piece of pre-stored identification-information 1-n in a memory 290 matched with the received identification-information 210, and sends a matching signal 230 to an identifier matching logic 250. As will be easily understood by those skilled in the art, the matching signal 230 may be a logic level, for example, a high logic level representing that a match is found and a low logic level representing that a match is not found, or the matching signal 230 may be a flag bit of the identification-information matching logic. Furthermore, the matching signal 230 may also be information containing other fields, for example, it may contain the numbering of the pre-stored identification-information matched with the identification-information and the numbering of the set of distribution information associated with the matched pre-stored identification-information (such as distribution information set 1) to facilitate subsequent logic operations.

In accordance with one embodiment of the present invention, in response to a matching signal 230 indicating that there is a match, an identifier matching logic 250 obtains an identifier 240 of the mobile terminal. The identifier matching logic 250 may obtain the identifier 240 from a gateway, but the present invention is not so limited. Then the identifier matching logic 250 determines at least one identifier matching rule. In accordance with one example of the present invention, the identifier matching logic 250 may determine the at least one identifier matching rule from a predetermined set of identifier matching rules. In accordance with another example of the present invention, the identifier matching logic 250 may also couple with an I/O module (not shown) of the server, so as to choose a desired rule depending on an input command of the operator, or may even receive new input rules. In accordance with the present invention, the identifier matching rule may include number matching, number segment matching, area matching, network-type matching and matching of mobile terminal model, but the present invention is not so limited.

After determining the identifier matching rule, the identifier matching logic 250 may send a rule signal 260 to a distributing logic 280. The rule signal may be of any form, for example, the rule signal 260 may be a string representing the content of the rule, or the rule signal 260 may be a previously stipulated encoded signal representing different rules, and the distributing logic may identify the encoded signal and determine the identifier matching rule. For another example, the rule signal 260 may be a pointer to a memory location, and the distributing logic may retrieve a corresponding rule from the memory according to this pointer. Next, the distributing logic may determine at least one piece of distribution information associated with the identifier based on the identifier matching rule and may send the determined distribution information to the mobile terminal with this identifier.

As used herein, the term “rule” refers to the associating relationship between the distribution information and the identifier. A rule may be stored in a memory, and may be implemented in a data structure including multiple fields, but the present invention is not limited in this aspect. For example, as shown in FIG. 2, the identifier matching rule includes a rule-ID field, an identifier field and a distribution-information field, the distributing logic 280 addresses the identifier matching rule determined, and then may retrieve the distribution information associated with the identifier 240 and send to the mobile terminal with the identifier 240. However, as those skilled in the art will understand, the identifier matching rule may be implemented in other manner. For example, it may be implemented into a pointer, and corresponding information may be retrieved from a corresponding memory location based on the pointer after the distributing logic 280 obtaining the rule. Additionally, the identifier matching rule may include more information as desired, such as information related to a priority of the distribution information, user's quality of service (QoS) level, and the like, but the present invention is not limited in this aspect.

Although only one rule set is shown in details in FIG. 2 for purpose of clarity and convenient explanation, those skilled in the art will appreciate that there may be a plurality of sets of rules and a plurality of sets of distribution information as desired, and one piece of pre-stored identification-information may correspond to more than one set of distribution information, one rule may also correspond to more than one piece of distribution information, the present invention is not limited in this aspect. It may also be appreciated by those skilled in the art that the method and system of the present invention may be used together with any encryption/decryption method used by those skilled in the art.

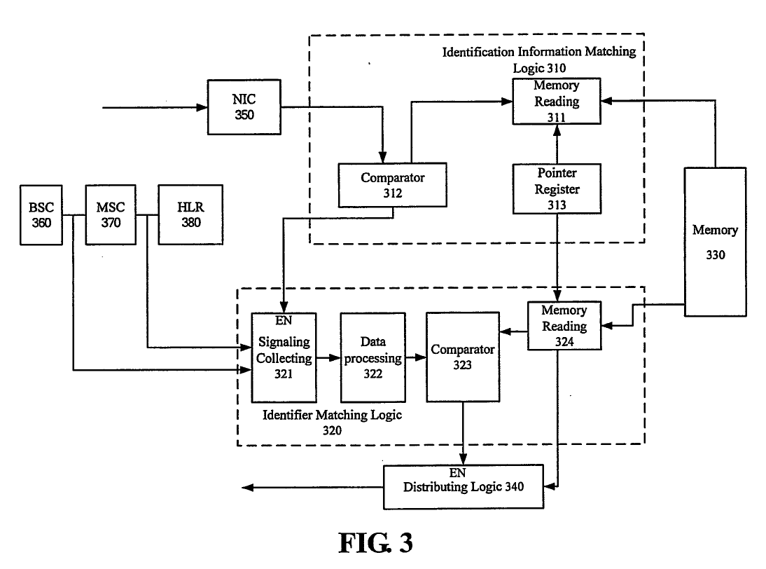

Now turn to FIG. 3. FIG. 3 shows exemplary hardware implementation of individual modules in the server of the present invention according to yet another embodiment of the present invention. As shown in the figure, an identification-information matching logic 310 may include a memory reading register 311, a comparator 312 and a pointer register 313, wherein the memory reading register 311 reads pre-stored identification-information from a memory 330 according to the pointer register 313. The comparator 312 may receive identification-information form a mobile terminal through a network interface card (NIC) 350, and compares the identification-information with pre-stored identification-information in the memory reading register. A matching result of the comparator 312 enables an identifier matching logic 320, so as to make a signaling collecting module 370 and a data processing module 322 to obtain an identifier of the mobile terminal for example from a base station controller (BSC) 360, a mobile switching center (MSC) 370 and a home location register (HLR) 380, and the identifier is compared through a comparator 323 with an identifier matching rule obtained by a memory reading register 324 from the memory. The comparator 323 sends a matched rule to the distributing logic 340 to send out distribution information determined according to the identifier matching rule. As is appreciated by those skilled in the art, although comparators 312 and 323 are shown as two separate elements for purpose of convenient for explanation, they may implemented as a same comparator, and the present invention is not limited in this aspect.

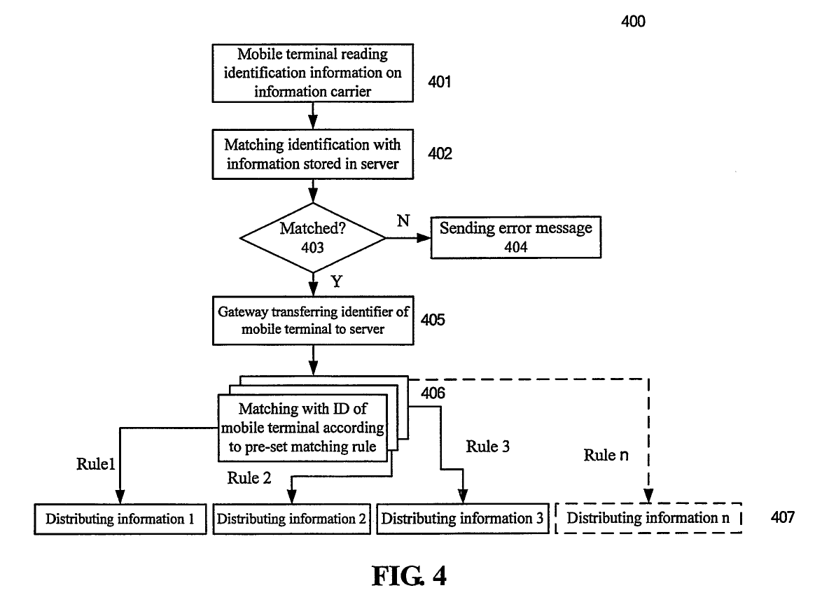

FIG. 4 illustrates a flow chart of information distributing process 400 of the present invention according to an embodiment of the present invention. First, at step 401, a mobile terminal with an identifier is used to read an information carrier to obtain at least one piece of identification-information carried on the information carrier. As noted previously, the identifier may be at least one of, for example, user agent (UA) data of the mobile terminal, user number of the mobile terminal, international mobile equipment identity, Mobile Country Code (MCC), Mobile Network Code (MNC), Location Area Code (LAC) or a combination thereof.

Next, as shown at 402, it is determined whether the at least one piece of identification-information is matched with at least one of multiple pieces of pre-stored identification-information. If there is no match, an error message is displayed (404), for example, indicating to the mobile terminal that the identification-information does not exist or has already expired. If there is a match, the identifier of the mobile terminal is obtained at 405.

Subsequently, at 406, at least one piece of distribution information associated with the identifier is determined from a set of distribution information associated with the at least one piece of identification-information according to at least one identifier matching rule matched with the identifier. As noted previously, the identifier matching rule may include at least one of number matching, number segment matching, area matching, network-type matching and matching of mobile terminal model, or a combination thereof. For example, as shown at 407, if a rule 1 is selected, distribution information 1 associated with the identifier is selected according the rule 1; while distribution information 2 associated with the identifier is selected according a rule 2 if the rule 2 is selected.

The system and method of the present invention may be applied to many applications. For instance, a user who wants to get information about the nearest garage while in a strange area may read a two-dimensional code with identification-information associated with the brand of his car adhered on his car by his mobile phone, and may send the identification-information to a server by the mobile phone. The server learns the cellular area to which the user belongs by obtaining the access number of the mobile phone, and sends the addresses of garages in this area for this brand to the user via a communication network, or the user may even obtain detailed electronic map if the network condition allows. Of course, other implementations may easily come to those skilled in the art, and these are all fall into the scope of the present invention.

As noted before, the identifier matching rule may be received externally such that customized rule or rule set may be achieved. For instance, a user who wants to throw a birthday party may make a rule as desired and customize a corresponding two-dimensional code, wherein the rule may include list of guests, numbers of mobile terminal users, information about location and time of the party, and operations to be performed associated thereto. The user may print the two-dimensional code on information carriers such as birthday cards, so that guests may read the two dimensional code with their mobile phones and send to a server. The server then distributes the information about location and time of the party to each guest read the customized two-dimensional code according to the customized rule, and sends the name of each guest read the two-dimensional code and pre-edited well-wishing messages to the user who is enjoying his/her birthday. Other applications of customized rule or rule set may come to those skilled in the art.

It may be seen that the technical effect of the present invention is to achieve flexible, substantially real-time, individualized and large scale distribution of information through mobile terminals under the condition of occupying less technology resource and equipment resource. An information provider may specify different user groups in a large geographic area, and may distribute different information in terms of user groups, such as information about dealers in different cities. As for a user, when he needs to get some information, he may consciously read an information carrier and send the identification-information to request for service from the server, instead of being disturbed by non-relevant information when it is not necessary; as for an information provider, he may provide users information in greater details and efficiency according to different rules, and may even perform statistics and analysis on users requesting for services to make corresponding schemes; as for a network operator, unnecessary network traffic is saved for other applications, since the information communication between users and the server is desired for both of them instead of aimless.

Furthermore, it may be seen from the above description of the present invention that the implementation of the invention requires no modification and variation to the mobile terminal and the network, and is suitable for any currently existing network such as GSM, GPRS, CDMA2000 or TDS-CDMA mobile communication network, or may be practiced through Internet, mobile Internet, Local area network, Wide area network and other networks, or even any network communication developed in the further, so the present invention has excellent applicability.

Based on the above description of the embodiments of the present invention, those skilled in the art may appreciate that the present invention includes multiple modules which may be integrated together or may be discrete. Although the systems in the figures of the present invention include specific modules, some modules may be removed or additional modules may be added according to particular applications. The modules may be implemented in hardware circuit, or may be implemented in a combination of hardware and firmware, or in a combination of hardware circuit, firmware and software. At the same time, those skilled in the art may find out that the method and system of the present invention require relatively less network resource, storage space and computation resource for data to be collected and analyzed, therefore fast, accurate, flexible, prompt, and even real-time, individuated and large scale distribution of information may be achieved.

Although flow diagrams may have been used herein to describe embodiments, the inventions are not limited to those diagrams or to corresponding descriptions herein. For example, flow need not move through each illustrated box or exactly in the same order as illustrated and described herein. In an embodiment of the present invention, information distributing may be performed in substantially real-time, in batch or at set timing.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

What claimed is:

1. A method of distributing information, comprising:
reading an information carrier using a mobile terminal with an identifier to obtain at least one piece of identification-information on the information carrier;
determining whether the at least one piece of identification-information is matched with at least one of multiple pieces of pre-stored identification-information, if matched:
determining at least one piece of distribution information associated with the identifier from a set of distribution information associated with the at least one piece of identification-information according to at least one identifier matching rule matched with the identifier.

2. The method of distributing information of claim 1, wherein the identifier comprises at least one of user agent data of the mobile terminal, user number of the mobile terminal, international mobile equipment identity, Mobile Country Code, Mobile Network Code, Location Area Code or a combination thereof.

3. The method of distributing information of claim 1, wherein the information carrier comprises at least one of barcode, two-dimensional code, RF identity tag, optically-recognizable character or a combination thereof.

4. The method of distributing information of claim 1, further comprising determining the at least one identifier matching rule matched with the identifier from a predetermined set of identifier matching rules.

5. The method of distributing information of claim 1, wherein the information carrier comprises a DM code, and the operation of reading a information carrier by a mobile terminal to obtain identification-information further comprises reading the DM code in an optical manner using the mobile terminal and decoding the DM code to obtain the at least one piece of identification-information.

6. The method of distributing information of claim 1, wherein the identifier is obtained from a gateway.

7. The method of distributing information of claim 1, wherein the identifier is stored locally.

8. The method of distributing information of claim 1, further comprising:
if the at least one piece of identification-information is not matched with any one of the multiple pieces of pre-stored identification-information, sending an error message to the mobile terminal.

9. The method of distributing information of claim 1, further comprising:
after the operation of ‘determining at least one piece of distribution information associated with the identifier from a set of distribution information associated with the at least one piece of identification-information according to at least one identifier matching rule matched with the identifier’, sending the determined at least one piece of distribution information to the mobile terminal with the identifier.

10. The method of distributing information of claim 1, wherein the identifier matching rule comprises at least one of number matching, number segment matching, area matching, network-type matching and matching of mobile terminal model, or a combination thereof.

11. A system of distributing information, comprising:
a communication network;
at least one mobile terminal having an identifier, the mobile terminal being coupled with the communication network and comprising:
a reading module for reading an information carrier to obtain at least one piece of identification-information on the information carrier; and
a communication module for sending the at least one piece of identification-information obtained by the reading module via the communication network; and
a server coupled to the communication network and communicating with the at least one mobile terminal, the server comprising:
a memory for storing multiple pieces of pre-stored identification-information;
an identification information matching logic for determining whether the at least one piece of identification-information is matched with at least one of the multiple pieces of pre-stored identification-information; and
a distributing logic for determining at least one piece of distribution information associated with the identifier from a set of distribution information associated with the at least one piece of identification-information according to at least one identifier matching rule matched with the identifier.

12. The system of distributing information of claim 11, wherein identifier comprises at least one of user agent data of the mobile terminal, user number of the mobile terminal, international mobile equipment identity, Mobile Country Code, Mobile Network Code, Location Area Code or a combination thereof.

13. The system of distributing information of claim 11, wherein the information carrier comprises at least one of barcode, two-dimensional code, RF identity tag, optically-recognizable character or a combination thereof.

14. The system of distributing information of claim 11, further comprising an identifier matching logic for determining the at least one identifier matching rule matched with the identifier from a predetermined set of identifier matching rules.

15. The system of distributing information of claim 11, wherein the information carrier comprises a DM code, and the reading module reads the DM code in an optical manner and decodes the DM code to obtain the at least one piece of identification-information.

16. The system of distributing information of claim 14, wherein the identifier matching logic obtains the identifier from a gateway.

7. The system of distributing information of claim 14, wherein the identifier matching logic obtains the pre-stored identifier locally.

18. The system of distributing information of claim 11, wherein if the at least one piece of identification-information is not matched with any one of the multiple pieces of pre-stored identification-information, the server sends an error message to the mobile terminal.

19. The system of distributing information of claim 11, wherein if the at least one piece of identification-information is matched with one of the multiple pieces of pre-stored identification-information, the server sends the at least one piece of distribution information determined by the distributing logic according to the at least one identifier matching rule matched with the identifier to the mobile terminal with the identifier.

20. The system of distributing information of claim 11, wherein the identifier matching rule comprises at least one of number matching, number segment matching, area matching, network-type matching and matching of mobile terminal model, or a combination thereof.
